(19) United States
(12) Patent Application Publication
(10) Pub. No.: US 2012/0129999 A1
(43) Pub. Date: May 24, 2012

(54) NANOCOMPOSITE INCLUDING HEAT-TREATED CLAY AND POLYMER

(76) Inventors: B. Dillon Boscia, West Henrietta, NY (US); Robert J. Kress, Rochester, NY (US); Robert C. Daly, Greece, NY (US); F. Douglas Kelley, Webster, NY (US)

(21) Appl. No.: 13/128,553

(22) PCT Filed: Nov. 11, 2009
(86) PCT No.: PCT/US09/63950

§ 371 Date: Jul. 28, 2011

Related U.S. Application Data
(60) Provisional application No. 61/114,492, filed on Nov. 14, 2008.

(51) Int. Cl. C08K 3/34

(52) U.S. Cl. 524/447; 524/445

(57) ABSTRACT

Disclosed are systems and methods for producing, and a composite including, a roasted aluminosilicate (e.g., halloysite). A uniform dispersion of an aluminosilicate can be obtained using roasted halloysite clay and subsequently combining it with a polymer in a melt mixing system to produce a composite.

This application is a national stage filing of International application PCT/US2009/063950 for NANOCOMPOSITE INCLUDING HEAT-TREATED CLAY AND POLYMER filed Nov. 11, 2009 which claims priority from U.S. Provisional Application No. 61/114,492 for a “NANOCOMPOSITE INCLUDING HEAT-TREATED CLAY AND POLYMER,” by B. D. Boscia et al., filed Nov. 14, 2008, priority is claimed from both applications, which are also hereby incorporated by reference in their entirety.

### CROSS-REFERENCE

The following co-pending US patent applications are cross-referenced and hereby incorporated by reference in their entirety: U.S. Ser. No. 11/469,128 for a “POLYMERIC COMPOSITE INCLUDING NANOPARTICLE FILLER,” by Cooper et al., filed Aug. 31, 2006 (published as US2007/0106006A1; issued Feb. 15, 2011 as U.S. Pat. No. 7,888,419); U.S. Ser. No. 11/531,459 for “RADIATION ABSORPTIVE COMPOSITES AND METHODS FOR PRODUCTION,” by Wagner et al., filed Sep. 13, 2006 (published as US2007/0148457A1; abandoned); U.S. Ser. No. 11/945,413 for a “NANOCOMPOSITE MASTER BATCH COMPOSITION AND METHOD OF MANUFACTURE,” by Boscia et al., filed Nov. 27, 2007; U.S. Ser. No. 12/027,402 for a “NANOCOMPOSITE METHOD OF MANUFACTURE,” by Fleischer et al., filed Feb. 7, 2008 (published as US2008/0262126A1); U.S. Ser. No. 12/126,035 for FIRE AND FLAME RETARDANT POLYMER COMPOSITES,” by Daly et al., filed May 23, 2008.

### TECHNICAL FIELD

Disclosed herein is a roasted aluminosilicate and method for producing the same. A uniform dispersion of an aluminosilicate can be obtained using roasted halloysite or kaolinite clay and subsequently combining it with a polymer in a melt mixing system to form a composite. The heat-treated clay is dispersed at the primary particle level in the polymer to produce improved mechanical properties and does not carry reactive water into the composite, which can degrade the polymer, nor does it produce high melt viscosity. Loadings of up to 50% by weight of the roasted aluminosilicate are possible.

### BACKGROUND ART

Clay-polymer nanocomposites are prepared by thermally processing or heating aluminosilicate clays to remove the water from them and then melt compounding them into the appropriate polymer. The thermally processed clays are particularly useful with polymers that degrade when heated in the presence of water such as polyethylene terephthalate and its copolymers, as well as providing improved mechanical strength to engineering resins like polypropylene and nylon. Examples of clays that can provide improved performance when thermally treated are halloysite and kaolinite.

A uniform nano-dispersion of an aluminosilicate in polyethylene terephthalate was prepared by first roasting halloysite (exposing to a thermal treatment) and then combining it with melted polyethylene terephthalate. The resulting composite can be made to loadings as high as 40-50% clay by weight without producing excessive loss in the polyethylene terephthalate molecular weight and does not have high melt viscosity associated with highly filled composites.

The utility and power of polymers comes about because of their remarkable physical properties and the wide array of fabrication processes that apply to them. Hundreds of monomers lead to thousands of polymers and copolymers that are useful in millions of applications. Sometimes the properties of these polymers are not enough and it is necessary to work with alloys and composites. Of particular interest have been polymer composites with inorganic materials such as talc, glass fibers, etc. However, the inclusion of the inorganic fillers can diminish other properties, make processing more difficult and increase the weight of the final part.

Recently, new polymer composite efforts have shifted toward nanocomposites. The primary basis for this shift is that the “nano-sized” particles have a higher ratio of surface area to mass and can produce excellent property improvements at much lower loading levels. Of particular interest have been platy clays and organoclays which produce thin sheets of aluminosilicates after proper treatment. (F. Gao; Materials Today; November, 50 (2004). (Q. H. Zeng, A. B. Yu, G. Q. Lu and D. R. Paul; J. of Nanosci. and Nanotech.; 5, 1574 (2005))

The use of platy clays as nanocomposite fillers requires that the clay particles must be diminished in size and the individual sheets of clay made available rather than aggregates of the clay platelets. (A. Esfandiari, H. Nazokdast, A.-S. Rashidi and M.-E. Yazdanshenas; J. of Appl. Sciences, 8 (3); 545 (2008).) Intercalation and exfoliation are the two processes that are carried out in order to wedge the sheets apart and then to separate them. The clay can be separated into sheets by monomer or solvent and then the polymer synthesized (in situ methods of composition formation) or an organoclay can be formed separately and added to the molten or mobile polymer. The organoclay preparation is normally a chemical process, which most commonly involves 30% or more of an organic compound such as a quaternary ammonium salt.

Many useful polymers for extruded and molded applications have limited utility with inorganic fillers, such as clays, because they degrade when heated in the presence of the moisture that is brought in by the filler. This is particularly true with polyethylene terephthalate (PET) and its copolymers, where the molecular weight of the polymer falls dramatically when even small amounts of water are present during melt processing, and with nylon, where degradation and color formation occur rapidly when moisture is present.

The presence of moisture has been a particular problem precluding the use of aluminosilicate clays with PET since there are considerable amounts of water within the structure of the clay particles, as well as adventitious water on the surface of the clay particles. Normal drying conditions for the clays (temperatures less than 220° C.) remove loosely held water but the more tightly held and structural water remains. The need to exfoliate and intercalate platy clays, further limits the use of clays with PET. Drying the clay before the treatment is ineffective because water or alcohol will be added during the treatments. And, drying at temperatures above the processing temperatures for PET, and more exotic high temperature materials such as PEEK or PEKK, will simply decompose the quaternary compounds commonly used for intercalation and exfoliation.

Improving the mechanical strength of PET is a worthwhile objective, but a very important potential improvement would be a reduction in moisture and gas permeability. For example, current PET technology lets too much through the wall of the bottle, both in and out of the bottle. Attempts to solve the plastic bottle permeability problem by using more exotic polymers like polyethylene naphthalate (PEN) have been stymied by the high cost of the material and other negative effects encountered with using PEN. Current technology for bottle making uses a multilayer technology with 5 to 7 total layers. PET alternates with layers of polymers such as ethylene vinyl acetate and ethylene vinyl alcohol copolymers or polyvinylidenedifluoride which are employed to reduce the permeability of the bottle. The complexity of this layered process is much higher and more costly than for a simple extrusion of PET alone. In another approach to solving the permeability problem, the formed bottle may be coated with a barrier layer either on the inside or the outside. Again, significant manufacturing complexity and cost have been added and a much less recyclable bottle has been produced. (M. Kegel and E Kosior, ANTEC 2001, Conference Proceedings, Vol III, Special Areas, 2715-2716 (2001).)

Platy clay has been shown to reduce gas and moisture permeability for a number of polymers (P. B. Messermith and E. P. Giannelis, J. Polym. Sci., Part A, Polym. Chem., 33, 1049 (1995)) including PET, as described in U.S. Pat. No. 5,876,812, hereby incorporated by reference in its entirety, but it remains both difficult and expensive to get the clay into PET without compromising other properties. In one experiment, several heavily treated platy clays were mixed in a twin screw extruder with PET or a PET copolymer to produce composites. (J. C. Matayabas, Jr. and S. R. Turner; Nanocomposite Technology for Enhancing the Gas Barrier of Polyethylene Terephthalate: Polymer-Clay Nanocomposites; Ed. T. J. Pinnavaia and G. W. Beall, John Wiley & Sons Ltd, 2000) The authors conclusions were that: “degradation upon the melt compounding of organoclay with PET is severe and the degradation cannot be overcome simply by increasing the inherent viscosity of the PET.”

Platy clay can be incorporated by in situ polymerization in the case of nylon or PET. This means placing the clay into the polymerization reactor and allowing the monomers or solvents to intercalate and exfoliate the clay before the polymerization occurs. An example of such a process involves exfoliation of the clay in ethylene glycol monomer and then polymerization under conditions that keep the clay dispersed. U.S. Pat. Nos. 5,578,672 and 5,721,306 discuss such a process. While that process can be used, it only allows for small amounts of clay incorporation, and it is both costly and inconvenient from a product manufacturing perspective—particularly for bottles and other containers.

Halloysite clay is a member of the Kaolin family of aluminosilicate clays but is quite unusual in that it commonly occurs in a tubular form that, after mechanical milling, does not require intercalation or exfoliation in order to be nano-dispersed within polymer matrices, for example as described in published U.S. Application 2007/0106006 for a Polymeric Composite Including Nanoparticle Filler (U.S. Ser. No. 11/469,128). While slight organic chemical surface treatment may be advantageous to these halloysite tubes, it is not required in some applications where inorganic or thermal treatments can produce the desired dispersion characteristics. If an organic surface treatment is used, it is at a level of less than 2%. The tubes can be mechanically separated and then heated at temperatures convenient for removing water that might interact with the polymer during extrusion and subsequent thermal processing.

As with all clays, halloysite can incorporate water in several different ways, ranging from very loosely held water on the surface to water that is part of the clay structure. Hydrated and “dehydrated” forms of halloysite exist at room temperature depending on the relative humidity. (J. L. Harrison and S. S. Greenberg; Clays and Clay Minerals; Vol 9: Issue 1: 374-377, (1960)) An X-ray diffractometer trace of halloysite taken directly from a waterlogged mine, showed a strong peak at a 2-theta value of 8.8 degrees corresponding to an interlayer spacing of 10.1 Angstroms for the fully hydrated halloysite. As the relative humidity was reduced, the peak corresponding to 10.1 halloysite was lost as a peak representing an interlayer spacing of 7.2 angstroms (2-theta value of 12.3 degrees) appeared. This dehydration is irreversible under normal atmospheric temperature and relative humidity conditions. However, there are large amounts of water (up to 20% by weight) available on heating in even the “dehydrated” 7 angstrom halloysite.

There may be a slight nomenclatural confusion about the two forms of halloysite. The “wet” halloysite (10.2 angstroms) is sometimes called endellite in the United Kingdom while the “dry” halloysite (7.3 angstroms) is sometimes called meta-halloysite. If a distinction is needed in the US, the two are described as “10 angstrom halloysite” and “7 angstrom halloysite.” None of the halloysite samples used for the experimentation described herein was 10 angstrom halloysite. All of the samples were much drier than the standard 7 angstrom halloysite.

Further heat treatment or roasting of the halloysite can remove water well beyond the level represented by even the 7 angstrom material. Under what are referred to herein as heat-treating or roasting conditions, the water level can be reduced sufficiently so that large amounts of halloysite can be introduced into a PET composite without appreciably degrading the polymer. The resulting composite has increased strength and the potential for lower permeability. Other polymers which show sensitivity toward water during extrusion which would benefit from a truly dry aluminosilicate are polytrimethylene terephthalate (PTT), polybutylene terephthalate (PBT), polyethylene napthalate (PEN) and copolymers of these types and copolymers of PET such as polyethylene-co-ethyleneoxyethylene terephthalate. Many PET materials actually have small amounts of other diols added (intentionally or unintentionally) which modify the processing crystallization rates and ultimate properties. Aliphatic polyesters and copolyesters and blends containing aliphatic polyesters and copolyesters are particularly susceptible to hydrolysis. Examples of such aliphatic polyester compositions include: polybutylene succinate (PBS), polycaprolactone (PCL), polylactic acid (PLA), the copolymers of butylene glycol with succinic and adipic acids (PBSA) and the copolymers of lactide with glucoside. These polyesters mentioned specifically are representative of many other members of the chemical class of moisture sensitive materials. The roasted halloysite or kaolinite also produce a strong mechanical benefit when incorporated into other polymer composites, including nylon and polypropylene.

### DISCLOSURE OF THE INVENTION

Disclosed in embodiments herein is a polymeric composite, comprising: a roasted aluminosilicate clay; and a polymer.

Further disclosed in embodiments herein is a method for producing a polymeric composite, comprising: exposing an aluminosilicate clay to a thermal treatment at a temperature of less than about 800° C.; and combining the thermally treated aluminosilicate clay with a polymer material to produce a composite.

Also disclosed in embodiments herein is a method for treating an aluminosilicate clay for use in a polymer composite, comprising: roasting the aluminosilicate clay at a temperature greater than about 350° C. and less than about 800° C. for at least about 3 hours; and combining the roasted aluminosilicate clay with a polymer in a melt mixing system to produce a composite.

### BRIEF DESCRIPTION OF THE DRAWINGS

FIG. 1 is a Transmission Electron Micrograph (TEM) of 600° C. roasted halloysite nanotubes;

FIG. 2 is a TEM of 600° C. roasted kaolinite tactoids and plates;

FIG. 3 is an Environmental Scanning Electron Micrograph (ESEM) of a 600° C. roasted 20% halloysite composite in polyethylene terephthalate (PET) (Example #1) at 10,000× magnification;

FIG. 4. is an ESEM of a 600° C. roasted kaolinite 20% composite in PET (Example #9) at a magnification of 10,000×;

FIG. 5 is an ESEM of a 400° C. roasted halloysite 10% composite in polypropylene (Example #13) at a magnification of 10,000×;

FIG. 6 is an ESEM of a 600° C. roasted kaolinite 10% composite in polypropylene (Example #16) at a magnification of 10,000×;

FIG. 7 is an ESEM of a 600° C. roasted halloysite 10% composite in nylon 6 (Example #19) at a magnification of 10,000×; and

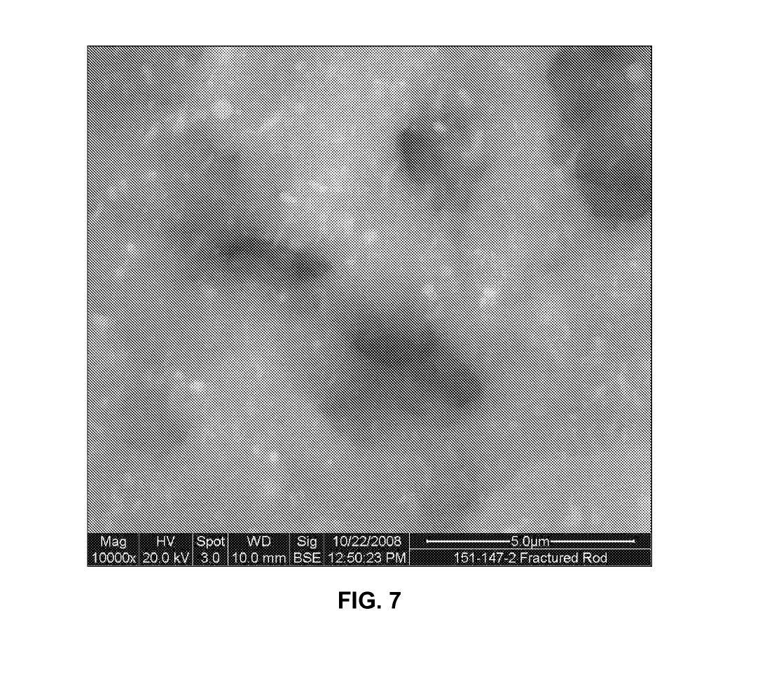

FIG. 8 is a SEM of a 600° C. roasted kaolinite 10% composite in nylon-6 (Example #21) at a magnification of 10,000×.

The various embodiments described herein are not intended to limit the invention to those embodiments described. On the contrary, the intent is to cover all alternatives, modifications, and equivalents as may be included within the spirit and scope of the disclosure and the appended claims.

### BEST MODE FOR CARRYING OUT THE INVENTION

As more particularly set forth below, the disclosed composites, and methods for production are directed to a uniform nano-dispersion of an aluminosilicate in a polymer (e.g., polyethylene terephthalate). In general, before preparing the composite, an aluminosilicate such as halloysite is first roasted. The roasted halloysite may then be combined with melted polyethylene terephthalate, for example, in an extruder. The resulting composite can be made to loadings as high as 40% clay by weight without producing excessive loss in the polyethylene terephthalate molecular weight, and does not have high melt viscosity associated with highly filled composites. Although described relative to several polymers, the disclosed composites and methods may also include polyolefins and polyamids and the polymer.

Various characteristics of heat treatment or roasting were considered. The following non-limiting examples are intended to illustrate the nature of the roasting operation, as well as to provide a representation of some of the ways in which the roasted aluminosilicate clay can be introduced into a polymer composite.

Materials Preparation—Heat Treatment and Drying

The clay samples used in these experiments were prepared by passing a refined and purified dry clay powder through an air mill and then drying the milled clay material at the temperatures described in the following examples—typically for 4 hours or more. Drying at 80° and 212° C. was done in a vacuum oven with the pressure reduced to <1 millitorr. Heat treating or roasting at temperatures from approximately 350° C. up to 600° C. were done in a Thermolyne muffle furnace. Pelletized PET was dried at about 150° C. in a circulating air, desiccant drier for at least about 24 hours.

As the water is removed during the clay roasting process, the characteristic infrared spectrum of halloysite is dramatically altered. After roasting at about 600° C. for more than 3 hours, there is essentially no water left and the infrared peaks at the —OH frequency have disappeared. However, the roasted halloysite remains in its tubular state based on the TEM micrographs. For kaolinite heated at 600° C., the —OH IR peaks disappear and the TEM micrographs show significant disruption in the platy clay particles indicating that they have become very disordered with considerable sheet separation.

The following non-limiting examples are intended to provide further illustration of the various embodiments disclosed herein. In the examples, the disclosure of temperatures and other characteristics are provided for purposes of describing the processes employed. Such characteristics, for example temperature, are intended to represent approximate temperatures and it will be appreciated that some variability is both anticipated an tolerated.

Composite Formation

### Example #1

A twin screw Thermo Fisher Scientific Prism extruder (16 mm, 40:1) was used to prepare the composite. The front of the extruder was set to provide heating at 305° C. while the central sections of the extruder barrel were set to temperatures of about 260° C. and the output die was at about 255° C. Halloysite which had been heated at up to 600° C. for 16 hours was loaded into a feeder. The weigh feeders (k-Tron) attached to the extruder were calibrated to add the halloysite and PET at about a 1:4 weight ratio. The PET feeder was set up at the front port of the extruder and the halloysite feeder was placed after the first mixing section of the screws.

The PET feeder and the screw (300 rpm, ˜60% of allowed torque) were turned on. When a stable strand had been obtained at the water bath, into which the extrudate was deposited, the halloysite feeder was turned on. When a stable composite strand was obtained, it was passed through the water bath and then pelletized. The strand was quite smooth and glassy with a grayish color.

The PET composite pellets were air dried and then crystallized at 150° C. for a period of 30 min and then a vacuum was applied to the 150° C. oven for 2 hours. By Differential Scanning calorimetry (DSC) no further crystallization occurred upon heating after this treatment.

### Example #2

A second halloysite:PET composite was obtained by repeating exactly the procedures for Example #1, except that the weigh feeders were calibrated to deliver the halloysite and PET at a 1:9 ratio. A stable strand was formed, pelletized and the pellets crystallized just as in Example #1.

### Example #3

A third halloysite:PET composite was obtained by repeating exactly the procedures for Example #1, except that the weight feeders were calibrated to deliver the halloysite and PET at a 3:7 ratio. A stable strand was formed, pelletized and the pellets crystallized just as in Example #1.

### Example #4

The procedure of Example #1 was run exactly as described, except that the halloysite was dried at 450° C. instead of 600° C. A stable strand was formed, pelletized and the pellets crystallized just as in Example #1.

### Example #5

The procedure of Example #1 was run exactly as described, except that the halloysite was heated at 400° C. instead of 600° C. A stable strand was formed, pelletized and the pellets crystallized just as in Example #1.

### Comparative Example #1

The procedure of Example #1 was run exactly as described, except that the halloysite was heated at a lower temperature, approximately 80° C., under reduced pressure (partial vacuum) for about 16 hours instead of 600° C. However, it was not possible to obtain a strand with enough strength to pass through the water bath and into the pelletizer. The extruder torque and back pressure dropped to almost zero. The material which exited the die had almost no melt viscosity and was extremely brittle upon cooling. A useful strand could not be formed.

### Comparative Example #2

The procedure of Example #1 was run exactly as described, except that the halloysite was dried at 212° C. under vacuum for 14 hours. However, it was not possible to obtain a strand with enough strength to pass through the water bath and into the pelletizer. The extruder torque and back pressure dropped to almost zero. The material which exited the die had almost no melt viscosity and was extremely brittle upon cooling. A useful strand could not be formed.

### Comparative Example #3

The procedure of Example #1 was run exactly as described, except that the halloysite was heated at 350° C. instead of 600° C. However, it was quite difficult to obtain a controllable strand exiting the die. The extruder operating conditions were quite marginal as to die back pressure and the formation of a stable strand indicating that the melt viscosity of the polymer was much reduced. It was not possible to obtain a strand that was reliable enough to produce pellets.

Analysis

The amount of water in a clay sample can be as high as 20% by weight in the visually dry clay powder. The water content of the variously dried clay samples was measured by the use of Thermal Gravimetric Analysis (TGA). A small sample of the heat treated clay was placed in a tared TGA pan. The pan was then placed on the balance arm of the TA Instruments 2950 Hi-Res TGA which was closed and prepared for operation. The sample furnace chamber temperature was raised gradually as the change in weight was measured.

Water exists in several forms in and on clays like halloysite. Water on the exterior surfaces (surface water) is held much less strongly than water between the aluminosilicate layers (intergallery water), and the structural water is very tightly held. The mildest heating conditions remove only surface water while the harshest remove the intergallery and structural water.

The surface water is completely removed by heating at 110° C. for 24 hrs. or at 80° C. under vacuum for 2 hrs. and normally amounts to about 2% of the clay sample by weight. However, some of the water remaining in the halloysite after these heating conditions comes out during PET compounding and degrades the PET so that its molecular weight is so low that it is no longer useful. Increasing the roasting temperature to 212° C. for 5 hrs. reduced the water content further to about 15%, but still the PET degradation was so severe that no useful polymer composite was obtained.

Heat treated halloysite was capable of producing a useful PET composite only after roasting at temperatures higher than 400° C. for more than 4 hours. The moisture contents by TGA ranged from less than 12% for 400° C. for 4 hours to less than 1% for heating at 600° C. for 16 hrs. Halloysite heated above 450° C. for more than 4 hrs. (containing about 10% residual water) produced an equivalent process and material to that roasted at 600° C. for 16 hrs. The difference in process performance seen in going from a 350° C. (14% water) to a 450° C. (10% water) heated clay indicates that at PET processing conditions, it is necessary to remove all of the nonstructural water to get a reasonable halloysite PET composite. At the highest temperatures and above, the clays are well on their way to becoming particulate ceramics. Roasting or thermal treatment, while described herein at various temperatures of 600° C. and below, may be possible at temperatures of up to or about 800° C. Heating at higher temperatures may result in reduced times required to drive the water out, such that a flash-type thermal treatment process may be possible.

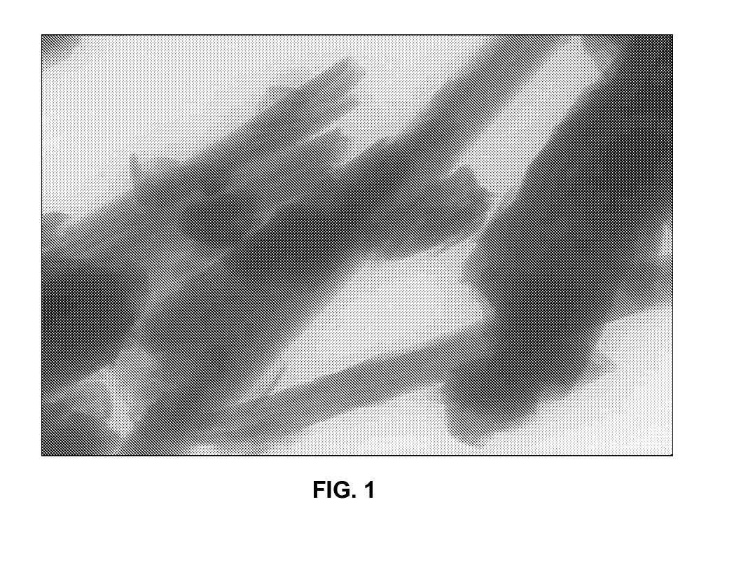

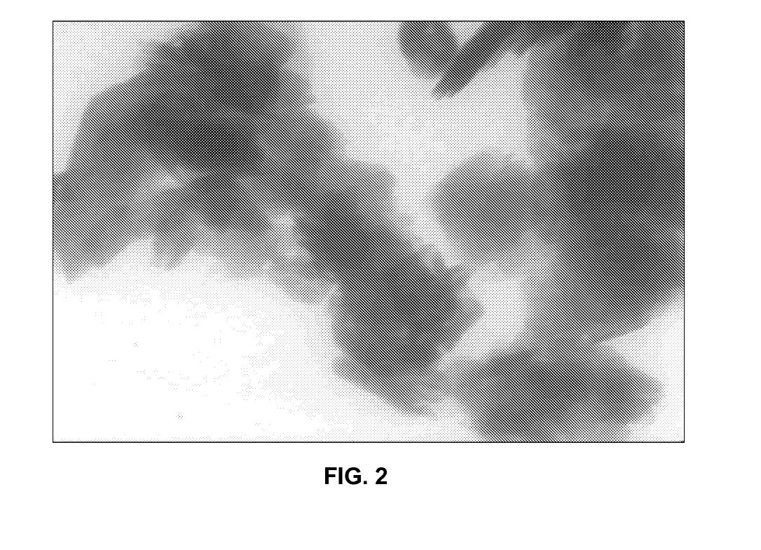

Examination of the transmission electron micrographs (TEM's) showed that the halloysite had maintained its tubular shape under all of the listed roasting conditions. A micrograph for halloysite after the most severe of the thermal processes (600° C., 16 hours) used in Example #1 is shown as FIG. 1. The impact of the 600° C. roasting on the kaolinite particles can be seen in FIG. 2 as the platy packets (kaolinite used in Example #9) have begun to expand.

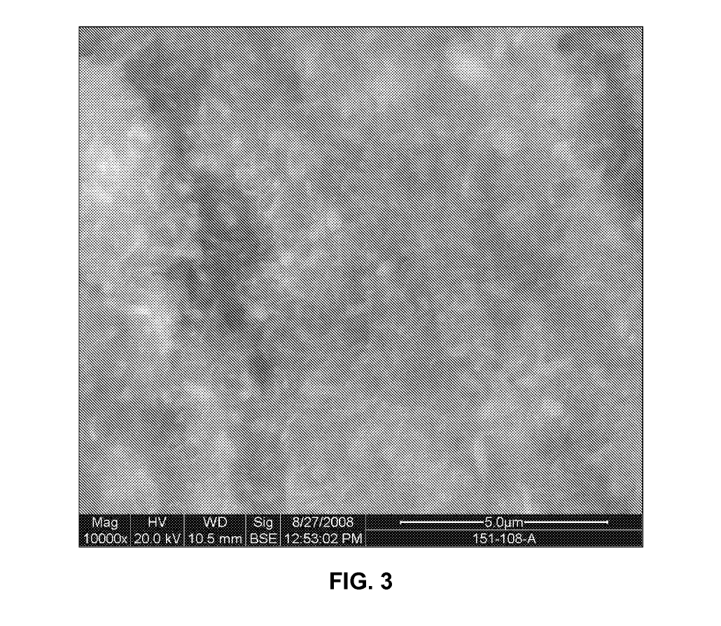

Extruded strands of the composites prepared in Examples #1-5 above were cooled in liquid nitrogen and snapped to produce a clean surface for electron microscopy. The strand end was mounted for SEM analysis and then placed into an FEI Quantum Environmental Scanning Electron Microscope. In all of the cited Examples #1-5, the halloysite was uniformly dispersed through the composite with essentially no large aggregates. A representative micrograph of Example #1 is shown as FIG. 3.

Composite Letdown

### Example #6

The 1:4 mixing ratio set forth in Example #1 produced 20% halloysite nanotube (referred to by NaturalNano as HNT™) composite PET pellets. The 20% HNT/PET pellets were dried at about 150° C. in a circulating air, desiccant drier for at least about 24 hours and subsequently mixed mechanically with dried PET pellets at a ratio of about 1:3 and placed in the first feed hopper of the extruder as described in Example #1. With the extruder set up as in Example #1, the mixture of composite and pure PET pellets was fed into the extruder and a strong capable strand was formed which was passed through a water bath, pelletized and crystallized just as in Example #1.

### Example #7

The dried 20% HNT composite PET pellets of Example #1 were mixed mechanically with dried PET pellets at a ratio of 1:9 and placed in the first feed hopper of the extruder as described in Example #1. With the extruder set as in Example #1, the mixture of pellets was fed into the extruder and a strong capable strand was formed which was passed through a water bath, pelletized and crystallized just as in Example #1.

Analysis

The composites (Examples #6 and 7) prepared by mixing the 20% halloysite with PET in order to prepare less loaded composites (5% and 2% respectively) were quite successful. There was no indication of further degradation of the PET and only normal PET drying was required for the concentrated halloysite composite prior to the letdown extrusion.

### Examples #8-11

Examples #8-11 were carried out exactly as Example #1 except for the identity and treatment of the clay in the composite, and the weigh feeders were calibrated to deliver the clay and PET at about a 1:9 ratio. Example #8 was milled kaolinite which had been dried at 80° C. under pump vacuum for 16 hrs. Example #9 was milled kaolinite which had been roasted at about 600° C. for 16 hrs. Example #10 was milled bentonite which had been dried at 80° C. under pump vacuum for 16 hrs. Example #11 was milled bentonite which had been roasted at about 600° C. for 16 hrs.

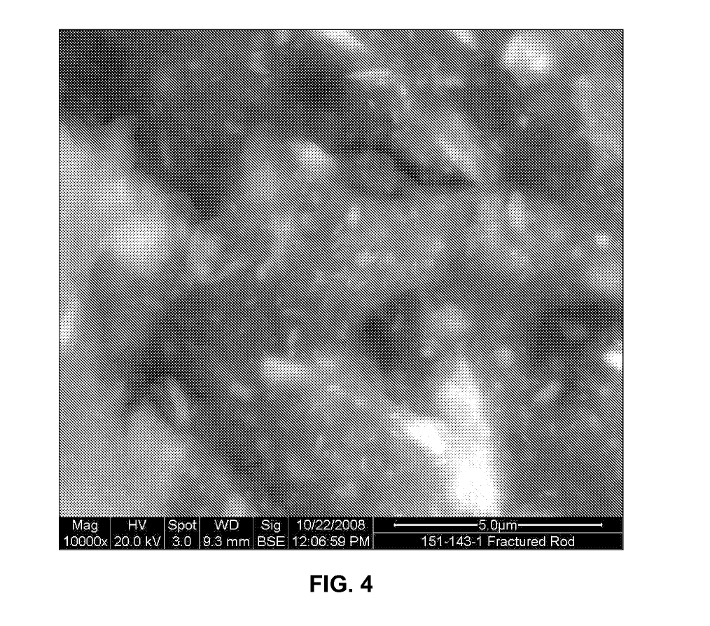

All of these samples produced dark strands and pellets and the normally dried clay samples had a very dark reddish color. While strands could be taken from all of the samples, the die pressure for the unroasted samples dropped to zero, indicating that the molecular weight of the PET had fallen dramatically and the composites were not useful. Strands of Examples #9 and #11 were examined with the SEM for the clay particle dispersion. The FIG. 4 micrograph shows that the kaolinite of Example #9 is quite well dispersed in the PET.

Polypropylene Composites with Thermally Treated Clay

### Examples #12-14

Composites of thermally treated HNT in Ineos H12-F-00 polypropylene (PP) were prepared at about a 10% loading using a twin screw Thermo Fisher Scientific Prism extruder (16 mm, 40:1). A dry blend of halloysite with the flake polypropylene was prepared simply by shaking a closed container of the mixture at a weight ratio of 1 part halloysite to 9 parts polypropylene. The front of the extruder was set to heating at 180° C. while the early central sections of the barrel were set to 200° C., the late central sections of the barrel at 210° C. and the output die was 205° C. Halloysite was thermally treated at several different conditions as shown in Table 1.

When a stable composite strand was obtained, it was passed through a water bath and then pelletized. The strand was quite smooth and glassy with a grayish color.

After cooling and drying, the pellets were placed in a Cincinnati Milacron VistaV 55 injection molder and ASTM test bars were prepared. After 24 hours, the bars were placed in a Tinius-Olsen H5KT Benchtop Universal Testing Machine and both tensile and flex testing analysis was performed.

### Comparative Example #4

Pellets of Ineos H12-G-00 polypropylene were placed in the injection molder and ASTM test bars were prepared for comparison with the test bars prepared from Examples #12-14.

TABLE 1

| | | Tensile Modulus | Flex Modulus |
|---|---|---|---|
| | Drying Conditions | (MPa) | (MPa) |
| Example #12 | 80° C., vacuum | 1892 | 1552 |
| Example #13 | 400° C. | 1749 | 1420 |
| Example #14 | 600° C. | 2010 | 1656 |
| Comparative | 80° C., vacuum | 1390 | 1261 |
| Example #4 | | | |

Analysis

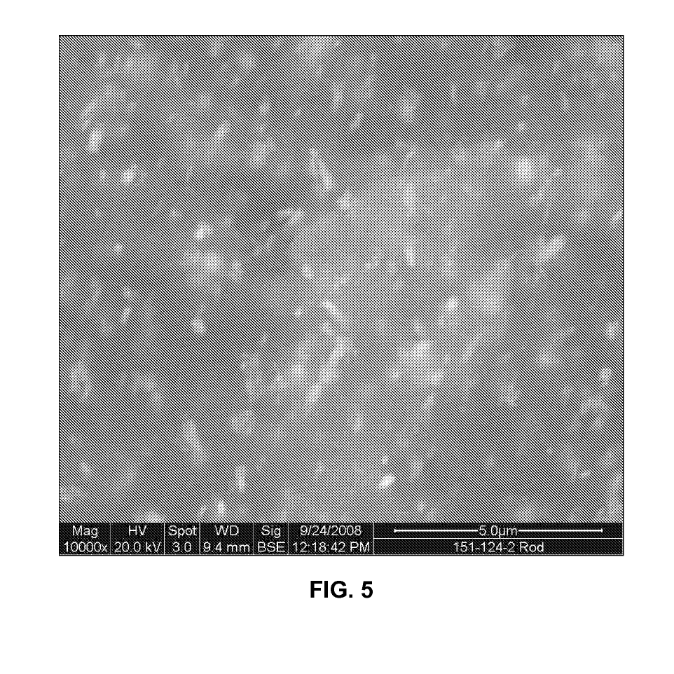

The modulus of each of the halloysite composites was much higher than that of the polypropylene itself. In each case during extrusion and injection molding, the filled polymers could be processed at lower temperatures or higher rates. The largest improvement was for Example #14 with the 600° C. heating. The micrograph of the composite of Example #13 in FIG. 5 shows that excellent dispersion was achieved for these samples.

### Examples #15-18

Examples #15-18 were carried out exactly as Examples #12-14 to prepare approximately 10% composites of clay in polypropylene, except for the identity and treatment of the clay in the composite. Example #15 contained an air milled kaolinite which had been dried at 80° C. in a vacuum oven for 16 hrs. Example #16 contained an air milled kaolinite which had been heated at 600° C. for 16 hrs. Example #17 contained an air milled bentonite which had been dried at 80° C. in a vacuum oven for 16 hrs. Example #18 contained an air milled bentonite that had been heated at 600° C. for 16 hrs.

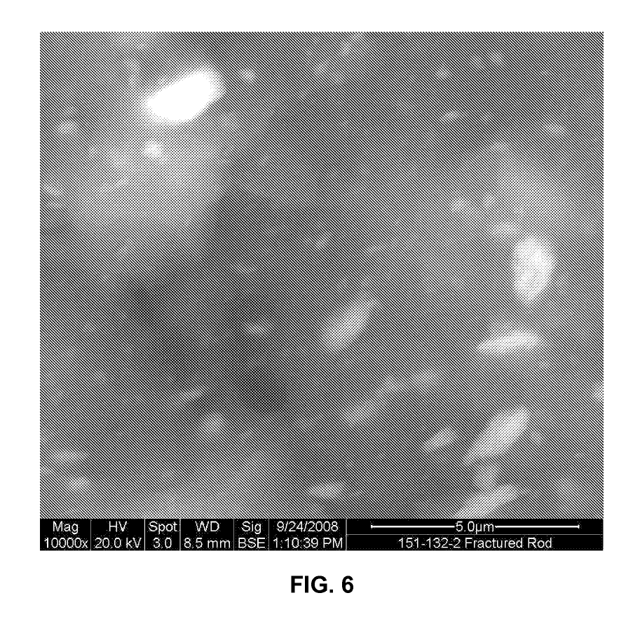

All four examples produced shiny, smooth strands that pelletized well, but both bentonite samples were highly colored. Example #15 produced a light tan strand while the strand for Example #16 was a very light cream color. The strands were investigated with the SEM to look for the dispersion of the clays compared to the halloysite samples. ESEM micrographs taken of the composite strands indicate that the roasted kaolinite (Example #16, FIG. 6) is considerably more dispersed than the normally dried kaolinite.

ASTM bars were molded of Examples #15 and 16 as described above and the bars were tested on the Tinius-Olsen. The mechanical results for Example #16, the 600° C. roasted kaolinite were essentially equivalent to those obtained for roasted halloysite from Example #14 in Table 1. The tensile modulus was 2020 MPa and the flexural modulus was 1667 MPa. The normally dried sample of kaolinite, Example #15, showed only modest improvement (tensile modulus of 1746 MPa and flexural modulus of 1237 MPa) over the control polypropylene, Comparative Example #4.

Analysis

The microscopic results for kaolinite indicated that while both the dried and the roasted kaolinite had dispersed in polypropylene, the roasted form was better dispersed. The high temperature processed kaolinite produced a much more substantial improvement in mechanical properties than did the normally dried clay. The bentonite samples were too highly colored to be useful and based on the extruder back pressure dropping to zero, significant polypropylene degradation had occurred during compounding.

Nylon-6 Composites with Thermally Treated Clays

### Example #19

Pellets of polycaprolactam (BASF B3K) were ground to produce a small particle nylon-6 flake. The flake was placed in a vacuum drying oven at 80° C. for about 16 hrs. under pumped vacuum to remove moisture. Air milled halloysite was placed in a furnace with a set temperature of about 600° C. and roasted for over 5 hrs. The thermally processed halloysite was cooled and then held at 60° C. until it was mixed thoroughly with the dry nylon flake at a ratio of about 1:9.

The twin screw Thermo Fisher Scientific Prism extruder (16 mm, 40:1) was used to prepare the composite. The front of the extruder was set to heating at 240° C. while the central sections of the barrel were set to 225° C. and the output die was 210° C. A weight loss k-Tron feeder was loaded with the mixture above and placed in the feeder port at the front of the extruder. The extruder screw was started and gradually brought to 400 rpm as the feeder was turned on. A smooth, translucent, shiny, ivory strand was obtained which was pulled into a water bath, pelletized and dried at 180° F. in a Novatec desiccant drier.

### Examples #20, 21 and 22

Examples #20, 21 and 22 were prepared exactly as Example #19, except that different clay fillers were used. Example #20 contained air milled halloysite that had been dried at 80° C. under vacuum for over 5 hrs. Example #21 contained air milled kaolinite that had been roasted for over 5 hrs at 600° C. Example #22 contained air milled kaolinite that had been dried at 80° C. for over 5 hrs. All three of the samples from Examples #20-22 produced smooth, translucent, shiny, ivory strands which were pelletized and dried.

### Comparative Example #5

Pellets of BASF B3K nylon were placed in the injection molder and ASTM test bars were prepared.

ASTM test bars were prepared by injection molding the four nylon composites (Examples #19-22) and Comparative Example #5 in a Cincinnati Milacron VistaV 55 injection molder. Molding conditions were optimized for each composition. The resulting bars were tested for tensile and flexural properties on a Tinius-Olson H5KT Benchtop Universal Testing Machine. The results for modulus are contained in Table 2.

TABLE 2

| | | Tensile Modulus | Flex Modulus |
|---|---|---|---|
| | Description | (MPa) | (MPa) |
| Example #19 | 600° C. halloysite | 3750 | 3700 |
| Example #20 | 80° C. vac. halloysite | 3630 | 3860 |
| Example #21 | 600° C. kaolinite | 3640 | 3650 |
| Example #22 | 80° C. vac. kaolinite | 3710 | 3900 |
| Comparative | BASF B3K | 2940 | 3140 |
| Example #5 | | | |

Analysis

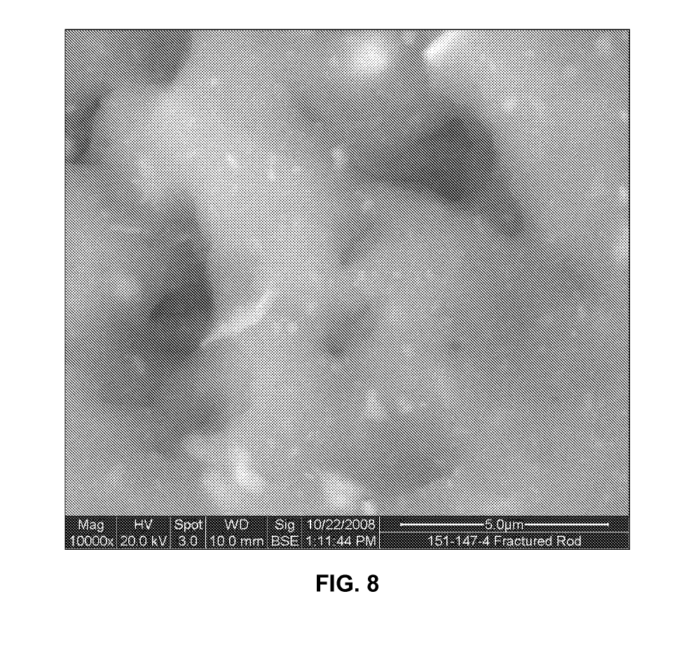

In nylon, the thermally processed halloysite and kaolinite did not show the same improvement over the normally dried clay samples, but, they did show considerable improvement in mechanical properties over the nylon control, Comparative Example #5. The dispersion of all of the samples in nylon was quite good with the halloysite being particularly well dispersed as seen in FIG. 8 for Example #19 (Table 2).

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

1. A polymeric composite, comprising:
a roasted aluminosilicate clay; and
a polymer.

2. The composite according to claim 1, wherein said polymer is selected from the group consisting of: polyester, aliphatic polyesters and copolyesters; blends containing aliphatic polyesters and copolyesters; nylons; polypropylenes; polyolefins; and polyamids.

3. The composite of claim 1, wherein said roasted aluminosilicate clay is halloysite.

4. The composite of claim 3, wherein said halloysite is roasted at a temperature less than about 800° C.

5. The composite of claim 1, wherein said roasted aluminosilicate clay is kaolinite.

6. The composite of claim 5, wherein said kaolinite is roasted at a temperature less than about 800° C.

7. The composite of claim 3, wherein said aluminosilicate clay is roasted at a temperature less than about 600° C.

8. The composite of claim 3, wherein at least some of said halloysite retains a tubular morphology and includes an agent therein.

9. The composite of claim 3, wherein at least some of said halloysite retains a tubular morphology.

10. The composite of claim 1, wherein said polymer includes those polymers suitable for wet applications selected from the group consisting of latexes; coatings; and paints.

11. The composite of claim 1, where said aluminosilicate clay is roasted at temperatures of at least about 400° C. for at least about 4 hours.

12. The composite of claim 1, where said aluminosilicate clay is roasted at temperatures of at least about 600° C. for at least about 2 hours.

13. The composite of claim 1, wherein said polymer is selected from the group consisting of: polytrimethylene terephthalate; polybutylene terephthalate; polyethylene napthalate; polyethylene terephthalate; polybutylene succinate; polycaprolactone; polylactic acid; and copolymers of the above, including polyethylene-co-ethyleneoxyethylene terephthalate, butylene glycol polymerized with succinic and adipic acids, and lactide polymerized with glucoside.

14. A method for producing a polymeric composite, comprising:
exposing an aluminosilicate clay to a thermal treatment to remove at least some structural water therefrom; and
combining the thermally treated aluminosilicate clay with a polymer material to produce a composite.

15. The method according to claim 14, wherein said thermal treatment removes substantially all of the structural water.

16. The method according to claim 15, wherein said thermal treatment reduces the weight of residual water in the aluminosilicate clay to less than about 14%.

17. The method according to claim 15, wherein said thermal treatment reduces the weight of residual water in the aluminosilicate clay to less than about 10%.

18. The method according to claim 15, wherein said thermal treatment maintains structure of the aluminosilicate clay after removal of substantially all of the structural water.

19. The method according to claim 14, wherein said thermal treatment includes heating to a temperature of at least 212° C. and less than about 800° C.

20. A polymeric composite produced in accordance with the method of claim 14.

21. The composite of claim 20, wherein said aluminosilicate clay is halloysite.

22. The composite of claim 21, wherein said halloysite is roasted at a temperature less than about 800° C.

23. The composite of claim 20, wherein said aluminosilicate clay is kaolinite.

24. The composite of claim 23, wherein said kaolinite is roasted at a temperature less than about 800° C.

25. The composite of claim 21, wherein said aluminosilicate clay is roasted at a temperature up to about 600° C.

26. The composite of claim 21, wherein at least some of said halloysite retains a tubular morphology and is suitable for being loaded with an agent.

27. A method for treating an aluminosilicate clay for use in a polymer composite, comprising:
roasting the aluminosilicate clay at a temperature greater than about 350° C. and less than about 800° C. for at least about 3 hours; and
combining the roasted aluminosilicate clay with a polymer in a melt mixing system to produce a composite.

28. The method according to claim 27, wherein said roasted aluminosilicate clay is halloysite.

29. The method according to claim 27, wherein said roasted aluminosilicate clay is kaolinite.

30. The method according to claim 28, wherein at least some of said halloysite is in a tubular form.

31. The method according to claim 27, wherein said polymer is a polyester.

32. The method according to claim 27, wherein said polymer is a copolymer.

33. The method according to claim 32, wherein said copolymer exhibits a sensitivity toward the presence of water during extrusion.

34. The method according to claim 27, wherein said polymer is selected from the group consisting of: polytrimethylene terephthalate (PTT); polybutylene terephthalate (PBT); polyethylene napthalate (PEN); polyethylene terephthalate (PET); polybutylene succinate (PBS), polycaprolactone (PCL); polylactic acid (PLA); and copolymers of the above (for example polyethylene-co-ethyleneoxyethylene terephthalate, butylene glycol polymerized with succinic and adipic acids (PBSA), lactide polymerized with glucoside, etc.).

35. The method according to claim 27, wherein said polymer includes those polymers suitable for wet applications including latexes, coatings and paints.

36. The method according to claim 30, wherein at least some of said halloysite in tubular form is loaded with an agent.
